(19) United States
(12) Patent Application Publication
(10) Pub. No.: US 2021/0396404 A1
(43) Pub. Date: Dec. 23, 2021

(54) Innovative System for Providing Hyper Efficient HVAC

(71) Applicant: Micah Laughmiller, Benbrook, TX (US)

(72) Inventor: Micah Laughmiller, Benbrook, TX (US)

(21) Appl. No.: 17/354,963

(22) Filed: Jun. 22, 2021

Related U.S. Application Data
(60) Provisional application No. 63/042,387, filed on Jun. 22, 2020.

(51) Int. Cl. F24F 3/14; F24F 6/14; F24F 11/63; F24F 11/77

(52) U.S. Cl. CPC F24F 3/1417; F24F 6/14; F24F 2006/008; F24F 11/77; F24F 11/63

(57) ABSTRACT

An air conditioning system configured to reduce humidity and temperature. The air conditioning system includes a closed loop desiccant system, and a closed loop cooling fluid system. The air conditioning system comprises a dehumidification system, a distillation system, and a refrigeration system. The dehumidification system reduces the temperature and humidity of the air. The distillation system separates the depleted liquid desiccant. The refrigeration system maintains liquid desiccant and cooling fluid at an inlet temperature. A flow of air is passed through the desiccant to reduce humidity. The flow of air is passed through a cooling fluid spray to reduce, temperature. The desiccant circulated to a heat collector for regeneration. The cooling fluid is recirculated to a heat collector for regeneration.

### CROSS-REFERENCE TO RELATED APPLICATIONS

This application claims the benefit of U.S. Provisional Application No. 63/042,387, filed Jun. 22, 2020, entitled “Innovative System for Providing Hyper Efficient HVAC,” the disclosure of which is hereby incorporated by reference in its entirety.

### TECHNICAL FIELD

The present disclosure relates to heating, cooling, ventilation, and air conditioning of commercial and residential spaces, and particularly reduction of humidity and temperature using renewable energy sources.

### BACKGROUND

Air conditioning system account for a substantial amount of energy consumption. in the United States. Most air conditioning systems rely on energy-intensive refrigeration techniques that require significant electrical energy to compress and expand refrigerants through refrigeration cycles. Therefore, there is a need for an air conditioning system to operate on a renewable powered source. Furthermore, there is a need for an air conditioning system to operate on a single renewable powered source.

Additionally, conventional air conditioning systems rely on solid desiccant substances or open-loop desiccant sources to decrease the humidity for conditioned air. While effective in decreasing the humidity of air, these current techniques require constant replacement or replenishment of the desiccant source. For example, solid desiccant sources must either be replaced or periodically cleaned to remove the captured water particles because water-saturated desiccants cannot effectively absorb water. On the other hand, current liquid desiccant systems require a constant outside source of desiccant to compensate for the desiccant becoming water-saturated. Therefore, there is a need for an air conditioning system that regenerates the liquid desiccant in a closed-loop without the need for an outside source.

Conventional air conditioning system also require the need for an outside source of cooling fluid (e.g., water) to evaporatively cool a flow of air. This constant need for additional water increases the cost of running an air conditioning system. Therefore, there is a need for an air conditioning system to circulates and cools water in a closed-loop without the need for an outside source.

### SUMMARY OF THE DISCLOSURE

The present disclosure provides an improved air conditioning system for efficient heating, cooling, ventilation, and air conditioning services when compared to current designs. The air conditioning system utilizes a closed loop desiccant system and a closed loop cooling fluid system. The air conditioning system comprises a dehumidification system, a distillation system, and a refrigeration system. A flow of air enters the dehumidification system, wherein the humidity and the temperature of the flow of air is reduced to a desired temperature and humidity for a conditioned space.

The present disclosure also provides a method of cooling and dehumidifying the air in the air conditioning system. The flow of ambient air is passed through a first desiccant that is sprayed from a closed loop desiccant reservoir to reduce humidity. The flow of ambient air passes through a cooling fluid sprayed from a closed loop reservoir to reduce temperature. The flow of ambient air passes through a second desiccant that is sprayed from the closed loop desiccant reservoir to produce a desired output humidity and output temperature. The first desiccant and the second desiccant circulate in the closed loop desiccant system, for regeneration. The water spray is recirculated for cooling and regeneration.

By having these three systems working in concert, this air conditioning system will work in any environment and without the need for an outside water source.

### BRIEF DESCRIPTION OF THE DRAWINGS

For a fuller understanding of the advantages provided by the disclosure, reference should be made to the following detailed description together with the accompanying drawing wherein:

FIG. 1 is a schematic diagram of an embodiment of an air conditioning system;

FIG. 2A is a schematic diagram of an embodiment of a dehumidification system;

FIG. 2B is a schematic diagram of an embodiment of a distillation system;

FIG. 2C is a schematic diagram of an embodiment of a refrigeration system;

FIG. 2D is a schematic diagram of an alternative embodiment of a refrigeration system;

FIG. 2E is a schematic diagram of an alternative embodiment of a distillation system;

FIG. 2F is a schematic diagram of an alternative embodiment of a dehumidification system;

FIG. 3 is a diagram of an embodiment of an environment in which systems and/or methods, described herein, may be implemented;

FIG. 4 is a diagram of example components of one or more devices of FIG. 3; and

FIG. 5 is a flow chart of an embodiment for air conditioning.

### DETAILED DESCRIPTION

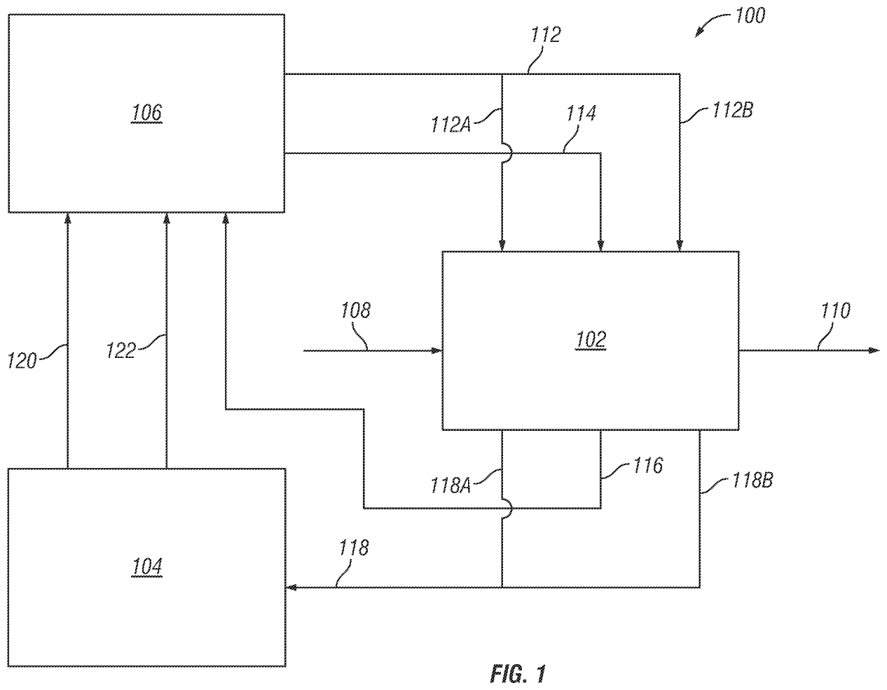

Referring to FIG. 1, an air conditioning system 100 for cooling a flow of air 108 using a closed loop desiccant system and a closed loop cooling fluid system is disclosed. In one embodiment, the air conditioning system 100 comprises a dehumidification system 102, a distillation system 104, and a refrigeration system 106. The dehumidification system 102 is configured to reduce the level of humidity in the flow of air 108 and adjust the temperature of the flow of air 108 before entering a conditioned space as a conditioned flow of air 110. in one example, air 108 flows into the dehumidification system 102 at an inlet temperature and humidity level and exits the dehumidification system 102 at an outlet temperature and humidity level. In an embodiment, the dehumidification system 102 utilizes flows of liquid desiccant 112A, 112B (collectively 112) and cooling fluid 114 to reduce the humidity of the air and to adjust the temperature of the air. In one example, the liquid desiccant 112 and the cooling fluid 114 enter the dehumidification system at an inlet temperature to condition the flow of air.

As the flows of liquid desiccant 118A, 118B (collectively 118) and cooling fluid 116 exit the dehumidification system 102, each stream 116, 118 has become depleted because the liquid desiccant 118 has become water saturated and the cooling fluid 116 temperature has either increased or decreased. The distillation system 104 is configured to separate the flow of depleted liquid desiccant 118 into a water portion 122 and desiccant portion 120. In one embodiment, the distillation system 104 utilizes a heat source to separate the depleted liquid desiccant 118 into substantially pure or completely pure streams of liquid desiccant 120 and water 122. Substantially pure may be understood to be at least 70 percent pure.

With continued reference to FIG. 1, the outlet streams of liquid desiccant 120 and water 122 leaving the distillation system 104 and the depleted cooling fluid 116 leaving the dehumidification system 102 enter the refrigeration system 106 for temperature regulation. In one embodiment, the refrigeration system 106 is configured to remove heat absorbed by the streams 116, 118 from the dehumidification and distillation systems. In one example, the refrigeration system 106 utilizes a heat collector to remove the heat from the liquid desiccant 120 and cooling fluid streams 116, 122 to return the streams 116, 120, 122 to the inlet temperature. An example of an inlet temperature may be from about 1.67° C. (35° F.) to about 1556° C. (60° F.), where the term “about” in the temperature ranges means a fluctuation within five percent. In one embodiment, the air conditioning system 100 utilizes a single thermal-powered heat source to power each system 102, 104, 106. For example, a single thermal-powered heat source may be powered by solar energy and/or waste energy. In other embodiments, the air conditioning system 100 may utilize more than one heat source to power each system 102, 104, 106. The air conditioning system 100 may be configured to operate solely from renewable energy and waste heat.

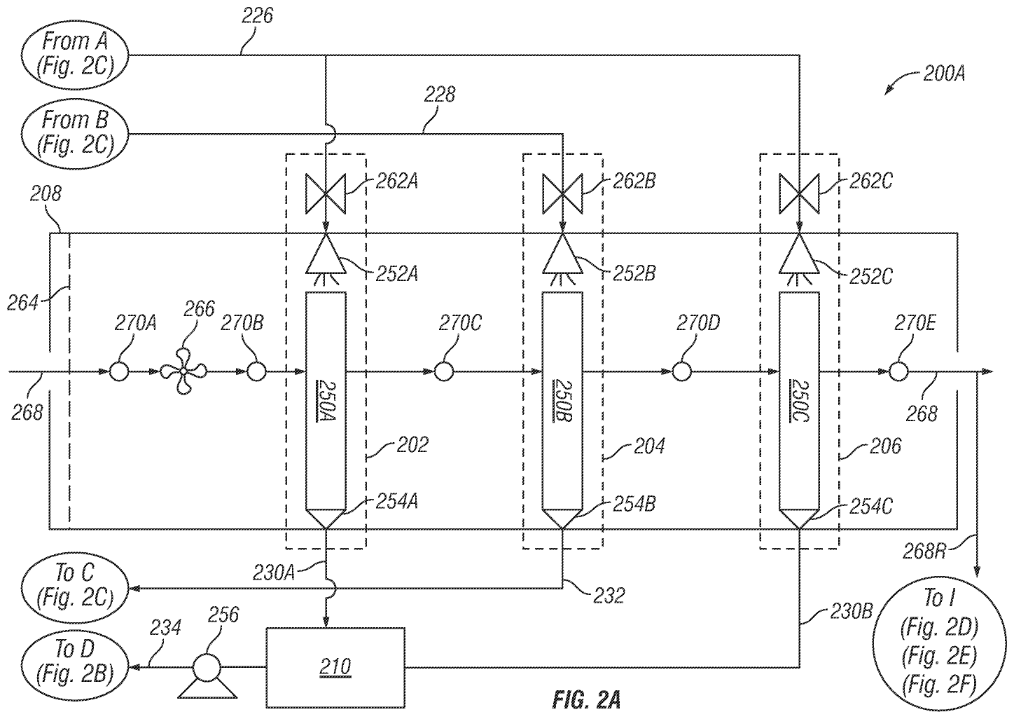

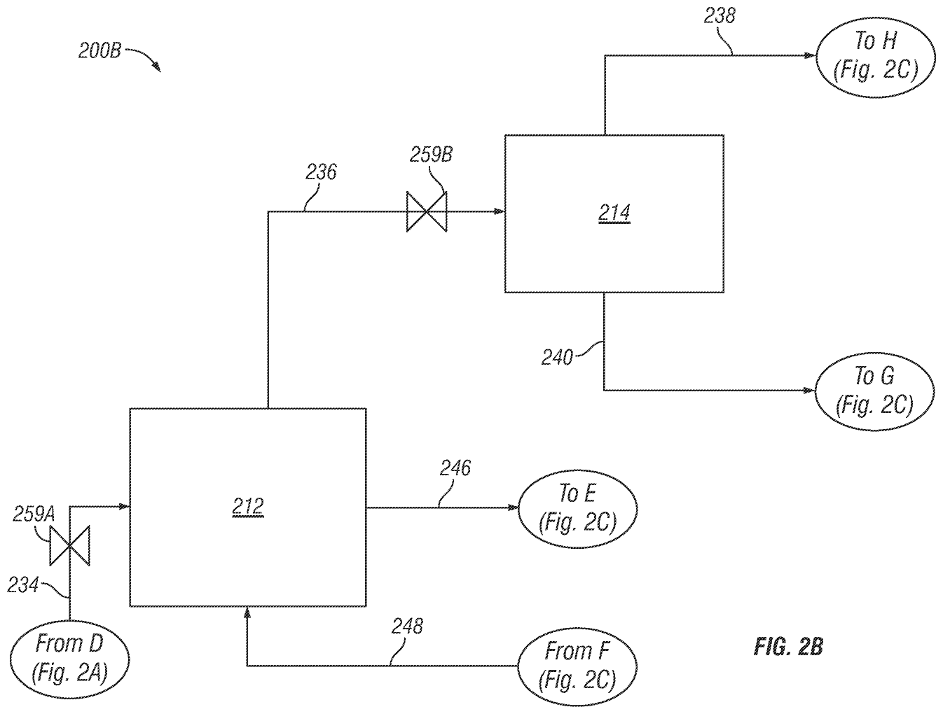

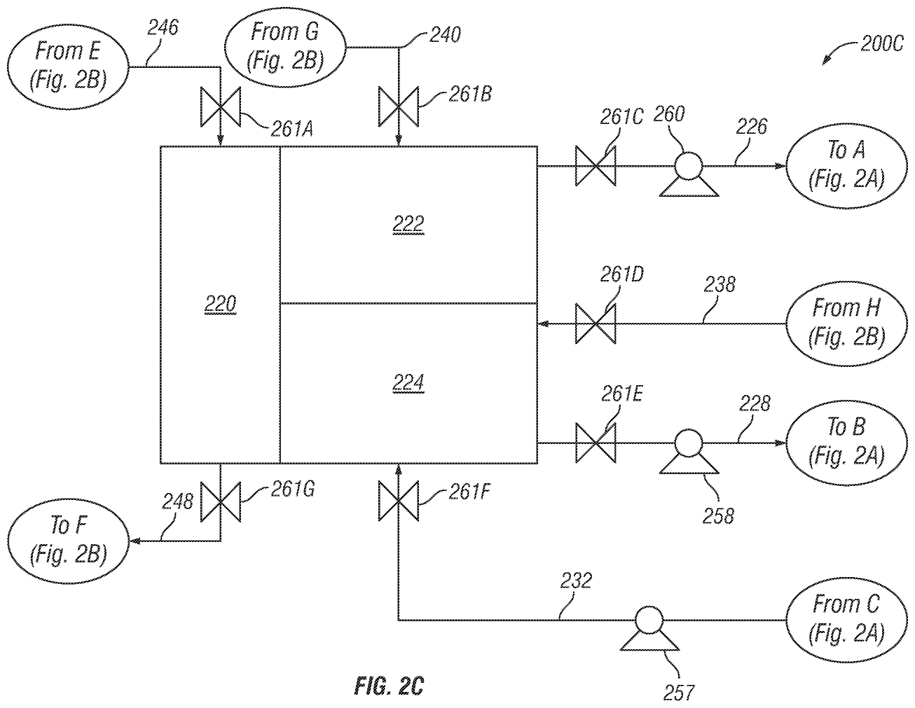

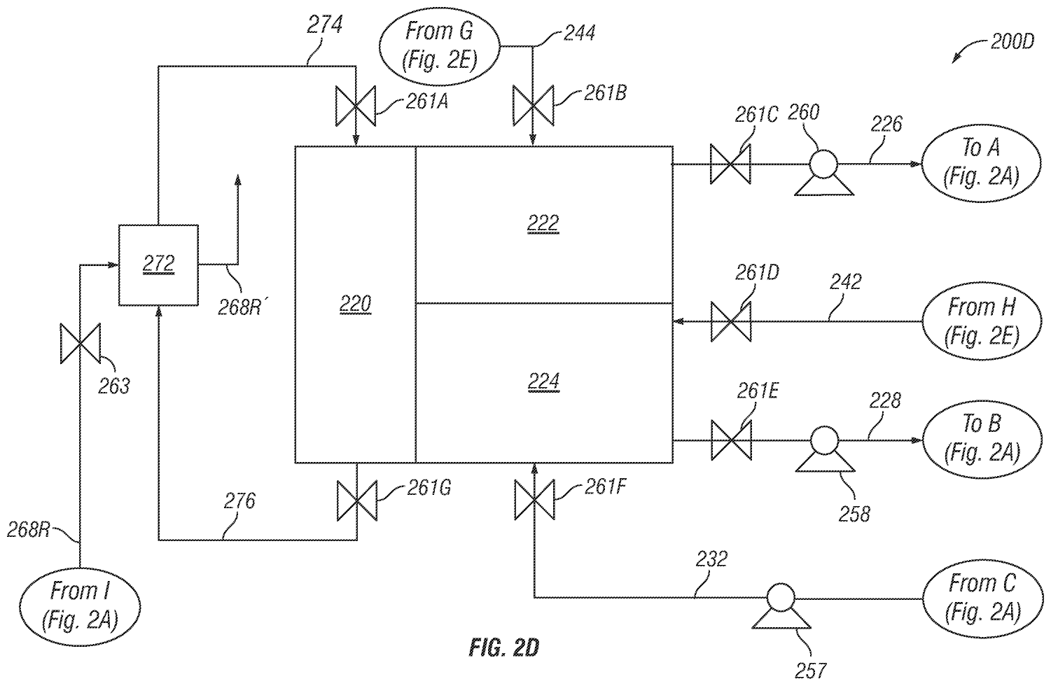

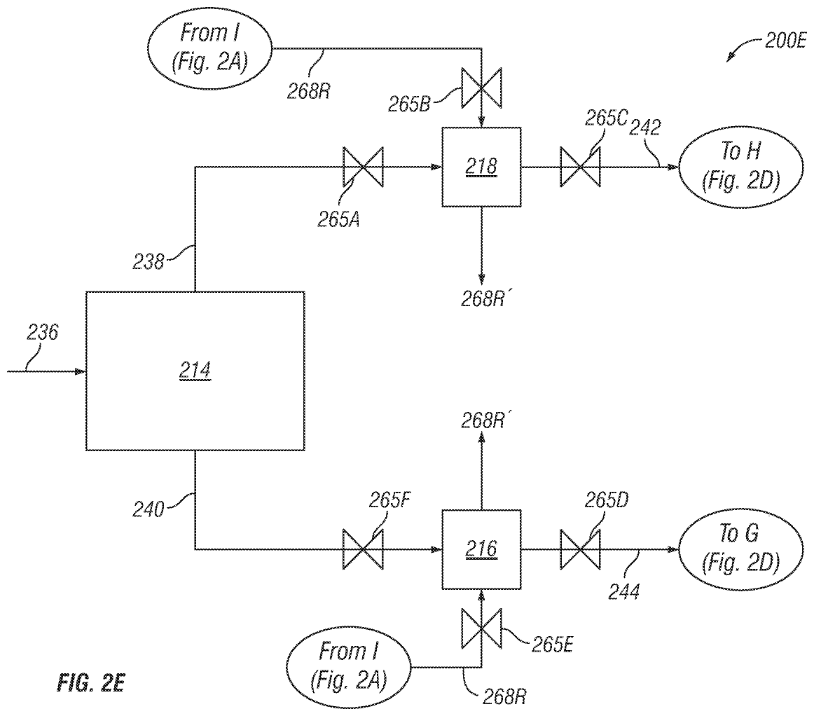

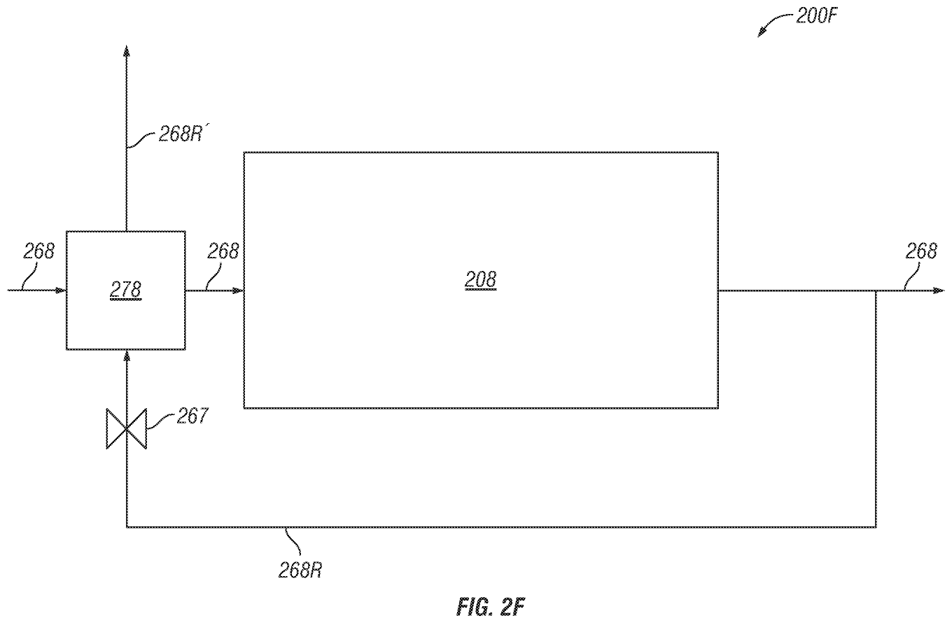

Referring to FIG. 2A, an embodiment of a dehumidification system 200A for treating a flow of air 268 using a closed loop desiccant system and a closed loop cooling fluid system is shown. A flow of air 268 enters the dehumidifier 208, wherein the humidity and the temperature of the flow of air 268 is reduced to a desired temperature and/or humidity for a conditioned space.

In one embodiment, the dehumidification system 200A may comprise a first desiccant device 202, and a cooling device 204. Optionally, a second desiccant device 206 may be implemented, wherein the first desiccant device 202, the cooling device 204, and the second desiccant device 206 are positioned in series. Depending on the demands of the conditioned space, the dehumidification system 200A may have more desiccant and cooling devices. In one embodiment, the flow of air 268 passes through the first desiccant device 202 first, the cooling device 204 second, and the second desiccant device 206 third, before exiting into a conditioned space. A fresh liquid desiccant 226 flows through the first desiccant device 202 and the second desiccant device 206 at an inlet temperature. The liquid desiccant is fresh when the water content is below fifty percent. As the flow of air 268 flows through the first desiccant device 202 and the second desiccant device 206, the fresh liquid desiccant 226 absorbs the water particles in the flow of air 268, thereby reducing the humidity of the flow of air 268. Once the fresh liquid desiccant 226 flows through the first desiccant device 202 and the second desiccant device 206 and absorbs the water particles, the fresh liquid desiccant 226 becomes a depleted liquid desiccant 230A, 230B because the depleted liquid desiccant 230A, 230B is water saturated. The liquid desiccant is depleted when the water content is greater than fifty percent. Additionally, the process of dehumidifying, the flow of air 268 may increase the temperature of the flow of air 268. The depleted liquid desiccant 230A, 230B exits the desiccant units 202, 206 and flows into a desiccant reservoir 210. In some embodiments, the dehumidification system 200A may utilize multiple desiccant reservoirs to capture the depleted liquid desiccant 230A, 230B. The collected depleted liquid desiccant 234 may be transferred to a distillation system 2008 via a pump 256.

With continued reference to FIG. 2A, a fresh cooling fluid 228 flows through the cooling device 204 at an inlet temperature, An example of an inlet temperature may be between about 1.67° C. (35° F.) and about 15.56° C. (60° F.), where the term “about” in the temperature ranges means a fluctuation within five percent. As the flow of air 268 flows through the cooling device 204, the fresh cooling fluid 228 lowers the temperature of the flow of air exiting from the first desiccant device 202 to a first temperature range. An example of a first temperature range may be from about 12.78° C. (55° F.) to about 29.44° C. (85° F.), where the term “about” in the temperature ranges means a fluctuation within five percent. After the fresh cooling fluid 228 removes the heat from the flow of air and passes through the cooling device 204, the fresh cooling fluid 228 becomes depleted 232 because its temperature may have increased or decreased. In one example, the cooling fluid is depleted when its temperature range is outside of the inlet temperature range. Additionally, the process of cooling the flow of air 268 may increase the humidity of the flow of air 268 as some of the water particles are absorbed by the flow of air 268. The depleted cooling fluid 232 exits the cooling device 204 flows into a fluid reservoir 224. In some embodiments, multiple fluid reservoirs may be utilized.

The dehumidification unit 208 may be configured to include a filter 264 at the inlet of the dehumidifier 208. Additionally, a fan 266 may be implemented at the inlet of the dehumidifier 208. The filter 264 may be employed to remove particles from the incoming flow of air 268. The filter 264 may be any type of material used to filter air, such as, for example, an activated carbon filter or any other material known in the art. The fan 266 may be configured to drive the flow of air 268 through the dehumidification unit 208 and into the conditioned space. In some embodiments, the dehumidification unit 208 may include multiple fans to drive the flow of air 268, depending on the demand requirements for the conditioned space. Additionally, the dehumidification unit 208 may include multiple filters along the dehumidification unit 208.

The first desiccant device 202 may be configured to include a first inert medium 250A, a first control valve 262A at the inlet, a first spraying head 252A between the first inert medium 250A and the first control valve 262A, and a first collector 254A at the end of the first inert medium 250A opposite the first spraying head 252A. The cooling device 204 may be configured to comprise a second inert medium 250B, a second control valve 262B at the inlet, a second spraying head 252B between the second inert medium 250B and the second control valve 262B, and a second collector 254B at the end of the second inert medium 250B opposite the second spraying head 252B. The second desiccant device 206 may also be configured to comprise a third inert medium 250C, a third control valve 262C at the inlet, a third spraying head 252C between the third inert medium 250 and the third control valve 262C, and a third collector 254C at the end of the third inert medium 250C opposite the third spraying head 252C. The inert mediums may comprise a housing packed with high surface area objects. The high surface area objects increase contact between the flow of air 268 and the fresh liquid desiccant 226 and the fresh cooling fluid 228 as the flow of air 268 passes through the dehumidification unit 208, which increases the amount of water the fresh liquid desiccant 226 absorbs.

With continued reference to FIG. 2A, the dehumidification unit 208 may be further configured to comprise air flow sensors 270A, 270B, 270C, 270D, and 270E to determine the properties of the air, such as, for example, temperature and humidity. In at least one embodiment, the dehumidification unit 208 comprises a first air flow sensor 270A located between the filter 264 and the fan 266 to provide a measurement of the flow of air 268 entering the dehumidification unit 208. A second air flow sensor 270B is located between the fan 266 and the first desiccant device 202 to provide a measurement of the flow of air 268 after the fan 266 drives the flow of air. A third air flow sensor 270C is located between the first desiccant device 202 and the cooling device 204 to provide a measurement of the flow of air 268 after dehumidification. A fourth air flow sensor 270D is located between the cooling device 204 and the second desiccant device 206 provide a measurement of the flow of air 268 after cooling. A fifth air flow sensor 270E is located after the second desiccant device 206 to provide a measurement after dehumidification. The dehumidification system 200A may further be configured to recycle a portion of the conditioned air flow 268R back into the air conditioning system.

Referring to FIG. 2B, in one embodiment, the distillation system 200B may comprise a heat exchanger 212 and a separator 212. The heat exchangers and separators may be any of the devices known in the art. The heat exchanger 212 may be connected to the desiccant reservoir 210 via a pump 256. The distillation system 200B is configured to separate the depleted liquid desiccant 234 into a liquid desiccant portion 240 and a water portion 238. In one example the liquid desiccant portion has no more than fifty percent water content. The liquid desiccant portion 240 is transferred to a desiccant reservoir 222 and the water portion 238 is transferred to the fluid reservoir 224. The heat exchanger 212 is configured to heat an incoming stream of depleted liquid desiccant 234 to a temperature causing the depleted liquid desiccant 234 to form a multi-phase fluid 236. In one embodiment, the heat exchanger 212 uses a working fluid 246, 248 execute the heat transfer of the depleted liquid desiccant 234. An example of a working fluid may be any refrigerant known in the cooling art that regulate temperature and separate fluids. In one embodiment, the multi-phase fluid 236 is a two-phase fluid comprising liquid desiccant and water vapor or liquid. The multi-phase fluid 236 enters a separator 212 wherein the water portion 238 of the fluid is separated from the liquid desiccant portion 240 of the fluid. An example of a temperature of the water portion 238 is between about 1.67° C. (35° F.) and about 1.56° C. (60° F.), where the term “about” in the temperature ranges means a fluctuation within five percent. An example of a temperature of the liquid desiccant portion 240 is between about 1.67° C. (35° F.) and about 15.56° C. (60° F.), where the term “about” in the temperature ranges means a fluctuation within five percent. The distillation system 200B may be configured with control valves to regulate the flow of fluids within the distillation system 200B. In one example, a control valve 259A may be positioned upstream of the heat exchanger 212 and a control valve 259B may be positioned between the outlet of the heat exchanger 212 and the inlet of the separator 212.

Referring to FIG. 2C, in one embodiment, the refrigeration system 200C may comprise a refrigerator 220, a fluid reservoir 224, and a desiccant reservoir 222. The refrigerator 220 is in thermal communication with the fluid reservoir 224 and the desiccant reservoir 222. The refrigeration system 200C may be configured to maintain the contents of the desiccant reservoir 222 and the fluid reservoir 224 at an inlet temperature. An example of an inlet temperature may be from about 1.67° C. (35° F.) to about 15.56° C. (60° F.), where the term “about” in the temperature ranges means a fluctuation within five percent. The refrigerator 220 may be configured to connect to the heat exchanger 212. A working fluid 246, 248 circulates between the refrigerator 220 and the heat exchanger 212, thereby enabling the working fluid 246 to absorb heat from the fluid reservoir 224 and the desiccant reservoir 222. As the higher temperature working fluid 248 circulates back to the heat exchanger 212, the higher temperature working fluid 248 rejects the heat it absorbed from the fluid reservoir 224 and the desiccant reservoir 222 onto the depleted liquid desiccant 234, thereby aiding in the formation of the multi-phase fluid 236. The water portion 238 of the separated two-phase fluid 236 is sent to the at least one fluid reservoir 224, wherein the refrigerator 220 cools the water portion 238 such that the water portion 238 reforms into fresh cooling fluid 228. Correspondingly, the liquid desiccant portion 240 of the separated two-phase fluid 236 is sent to the second desiccant reservoir 222, wherein the refrigerator 220 cools the liquid desiccant portion 240 such that it reforms into fresh liquid desiccant 226.

With continued reference to FIG. 2C, the refrigeration system 200C may also be configured to transfer the fresh liquid desiccant 226 in the desiccant reservoir 222 to the first desiccant device 202 and the second desiccant device 206 (if employed) for dehumidification of a flow of air 268. Similarly, the refrigeration system 200C may be configured to transfer the fresh cooling fluid 228 from the fluid reservoir 224 to the cooling device 204 for cooling of the flow of air 268. In at least one embodiment, the refrigeration system 200C utilizes a desiccant pump 260 to drive the fresh liquid desiccant 226 from the desiccant reservoir 222 to the first desiccant device 202 and the second desiccant device 206 (if employed) for dehumidification of the flow of air 268. The refrigeration system 200C may also be configured to utilize a pump 257 to drive the depleted cooling fluid 232 into the fluid reservoir 224 and a pump 258 to drive the fresh cooling fluid 228 from the fluid reservoir 224 to the cooling device 204. The refrigeration system 200C may be configured with control valves to regulate the flow of fluids within the refrigeration system 200C. In one example, control valves 261A, 261G may be positioned at the inlet and outlet of the refrigerator 220. Additionally, control valves 261B, 261C may be positioned at the inlet and outlet of the second desiccant reservoir 222. Additionally, control valves 261D, 261E, 261F may be positioned at the inlets and outlet of the fluid reservoir 224.

In an alternative embodiment, as shown in FIG. 2D, the refrigeration system 200D may be configured to utilize heat exchanger 272, instead of, or in conjunction with, heat exchanger 212. For example, the refrigeration system 200D may be configured where the refrigerator 220 is connected to heat exchanger 272. A working fluid 274, 276 is configured to circulate between the heat exchanger 272 and the refrigerator 220, thereby enabling the working fluid 274 to absorb heat from the at least one fluid reservoir 224 and the second desiccant reservoir 222. The working fluid 276 rejects this absorbed heat upon circulating through the heat exchanger 272. This configuration enables the refrigerator 220 to maintain the fluid reservoir 224, and the desiccant reservoir 222 at the inlet temperature, which is from about 1.67° C. (35° F.) and about 15.56° C. (60° F.), where the term “about” in the temperature ranges means a fluctuation within five percent. In another example, recycled conditioned air 268R is supplied to the heat exchanger 272, wherein the recycled conditioned air 268R receives the rejected heat from the working fluid 276. After removing the heat from the working fluid 276, the heated recycled air 268R′ may be purged from the air conditioning system.

The refrigeration system 200D may also be configured to utilize a pump 257 to drive the depleted cooling fluid 232 into the fluid reservoir 224 and a pump 258 to drive the fresh cooling fluid 228 from the fluid reservoir 224 to the cooling device 204. The refrigeration system 200D may be configured with control valves to regulate the flow of fluids within the refrigeration system 200D. In one example, control valves 261A, 261B may be positioned at the inlet and outlet of the refrigerator. Additionally, control valves 261B, 261C may be positioned at the inlet and outlet of the second desiccant reservoir 222. Additionally, control valves 261D, 261E, 261F may be positioned at the inlets and outlet of the fluid reservoir 224. Additionally, a control valve 263 may be positioned at the inlet of the heat exchanger 272.

The air conditioning system may be configured to recycle a portion of the conditioned air to assist in the cooling of various processes in the air conditioning system. In one embodiment, as shown in FIG. 2E, a portion of recycled conditioned air 268R is supplied into the fluid cooler 218 to assist in condensing the stream of water 238 exiting the separator 212. After cooling the water 238 into the water portion 242, the heated recycled air 268R′ may be purged from the air conditioning system. Additionally, a portion of recycled conditioned air 268R may be supplied into the liquid desiccant cooler 216 to assist in cooling the liquid desiccant portion 240 exiting the separator 212. After cooling the liquid desiccant portion 240 into cooled liquid desiccant portion 244, the heated recycled air 268R′ may be purged from the air conditioning system. The distillation system 200E may be configured with control valves to regulate the flow of fluids within the refrigeration system 200E. In one example, control valves 265A, 265B, 265C may be positioned at the inlets and outlet of the cooler 218. Additionally, control valves 265D, 265E, 265F may be positioned at the inlets and outlet of the cooler 216.

In another embodiment, as shown in FIG. 2F, a portion of recycled conditioned air 268R is supplied into a heat exchanger 278 that is positioned at, or prior to, the entrance of the dehumidifier 208, thereby enabling the entering flow of air 268 to be cooled before treatment in the dehumidifier 208. After removing the heat from the flow of air 268, the heated recycled air 268R′ may be purged from the air conditioning system. The dehumidification system 200F may be configured with a control valve to regulate the flow of fluids within the dehumidification system 200F. In one example, a control valve 267 may be positioned at the inlet of the dehumidifier.

The air conditioning system 100 is configured to handle any combination of 100% outdoor air and 0% indoor air all the way to 0% outdoor air and 100% indoor air. The air conditioning system 100 is also configured to effectively filter air because the air directly may interact with an ionized salt spray in the form of a liquid desiccant spray. Pathogens or allergens that are captured will be boiled repeatedly without a way to escape. An optional add on to the air conditioning system 100 is an ultraviolet light C wave. These addons increase the filtration and killing of particulates in the air up to 99.997%.

In some embodiments, the air conditioning system 100 is configured without compressors or toxic refrigerants. The mass flow rate and therefore thermal flow rate of both the water and liquid desiccant are significantly less than the total mass of their respective reservoirs. This allows the combination of mixing of liquids and the heat removed by the refrigeration system to keep the entire system from heating up over time. By having these three systems working in concert, this design will work in any environment and without the need for an outside water source. However, a makeup water line could be included for the circumstances when the output desired humidity is higher than the input.

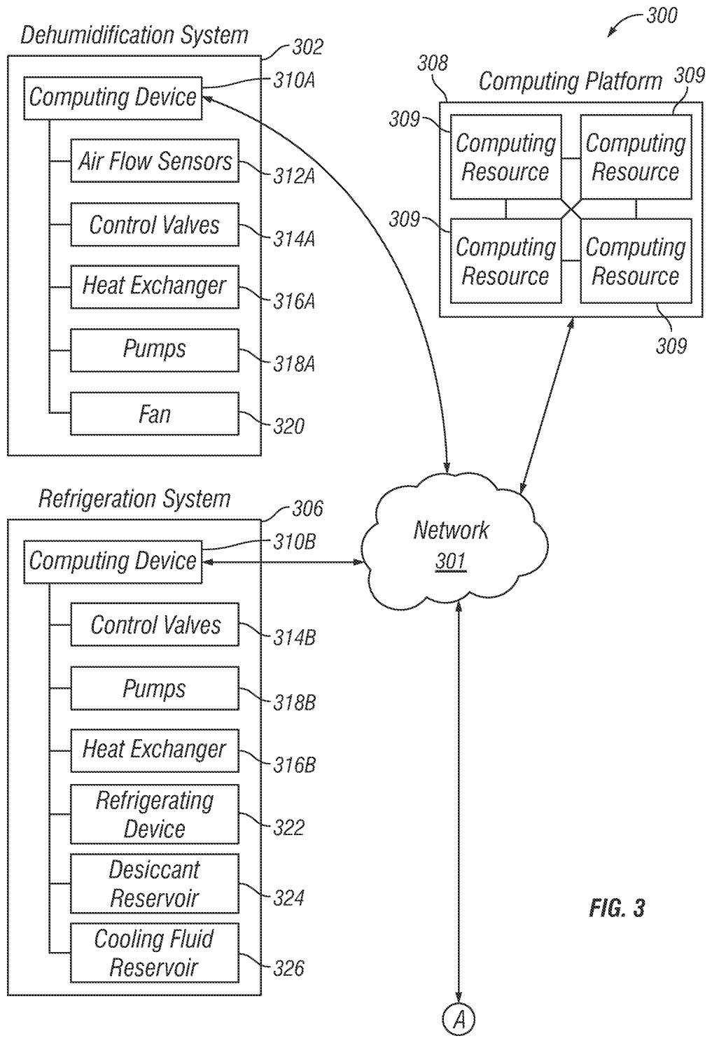

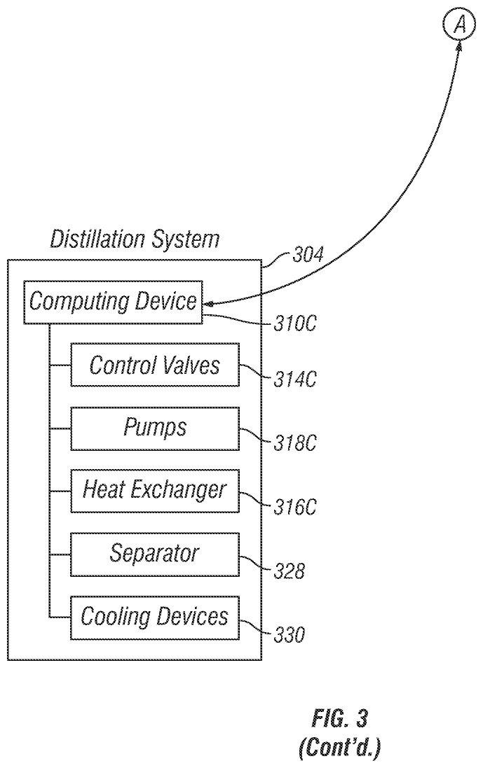

Referring to FIG. 3, a diagram of an embodiment of an environment 300 in which systems and/or methods may be implemented is illustrated. As shown in FIG. 3, the environment 300 may include a dehumidification system 302, a distillation system 304, a refrigeration system 306, a computing platform 308, and a network 301. Devices of environment 300 may interconnect via wired connections, wireless connections, or a combination of wired and wireless connections.

The dehumidification system 302 includes a computing device 310A, air flow sensors 312A, control valves 314A, heat exchangers 316A, pumps 318A, and fans 320. The computing device 310A may include a user device (e.g., a laptop computer, a desktop computer, etc.), a computing device, a server, a group of servers, and/or the like. The distillation system includes a computing device 310C, control valves 314C, heat exchangers 316C, pumps 318C, a separator 328, and cooling devices 330. The refrigeration system includes a computing device 310B, control valves 314B, pumps 318B, heat exchangers 316B, refrigerator 322, desiccant reservoir 324, and a cooling fluid reservoir 326.

In some embodiments, the computing devices 310A, 310B, 310C may be implemented in a cloud environment. For example, computing devices 310A, 310B, 310C may be implemented by one or more computer devices of a cloud computing environment or a data center.

The computing platform 308 includes one or more devices capable of receiving, generating, storing, processing, and/or providing information associated with determining compliance of products with regulations. For example, the computing platform 308 may include a server, a group of servers, and/or the like. In some embodiments, the computing platform 308 may be partially or entirely implemented in cloud computing environment.

A cloud computing environment includes an environment that delivers computing as a service, whereby shared resources, services, etc. may be provided to the computing devices 310A, 310B, 310C and/or computing platform 308. A cloud computing environment may provide computation, software, data access, storage, and/or other services that do not require end-user knowledge of a physical location and configuration of a system and/or a device that delivers the services.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

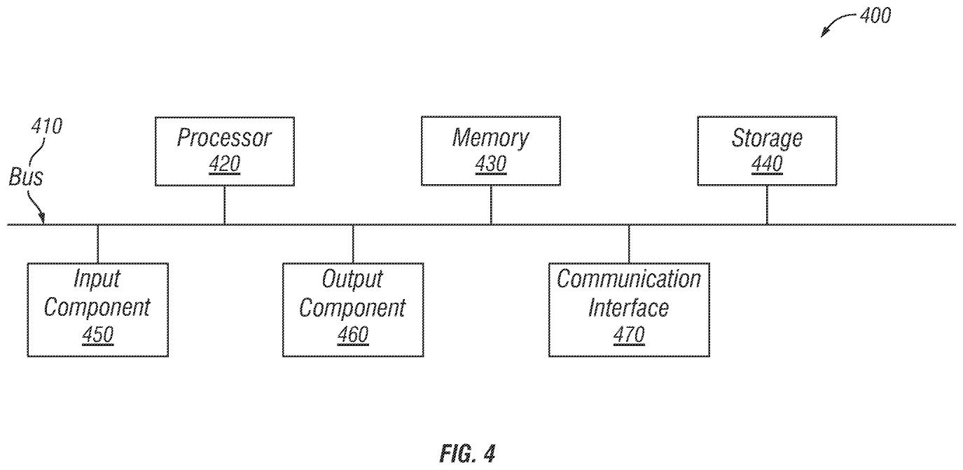

Referring to FIG. 4, a diagram of example components of a device 400. The device 400 may correspond to the computing devices 310A, 310B, 310C and/or computing resource 309. In some embodiments, the computing devices 310A, 310B, 310C and computing resource 309 may include one or more devices 400 and/or one or more components of the device 400. As shown in FIG. 4, the device 400 may include a bus 410, a processor 420, a memory 430, a storage component 440, an input component 450, an output component 460, and a communication interface 470.

Bus 410 includes a component that permits communication among the components of the device 400. Processor 420 is implemented in hardware, firmware, or a combination of hardware and software. The processor 420 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the processor 420 includes one or more processors capable of being programmed to perform a function. Memory 430 includes a random access memory (RAM), a read only memory (ROM), and/or another type of dynamic or static storage device (e.g., a flash memory, a magnetic memory, and/or an optical memory) that stores information and/or instructions for use by processor 420.

Storage component 440 stores information and/or software related to the operation and use of device 400. For example, storage component 440 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 450 includes a component that permits the device 400 to receive information, such as via user input (e.g., a touch screen display, a keyboard, a keypad, a mouse, a button, a switch, and/or a microphone). Additionally, or alternatively, input component 450 may include a sensor for sensing information (e.g., a global positioning system (GPS) component, an accelerometer, a gyroscope, and/or an actuator). Output component 460 includes a component that provides output information from device 400 (e.g., a display, a speaker, and/or one or more light-emitting diodes (LEDs)).

Communication interface 470 includes a transceiver-like component (e.g., a transceiver and/or a separate receiver and transmitter) that enables device 400 to communicate with other devices, such as via a wired connection, a wireless connection, or a combination of wired and wireless connections. Communication interface 470 may permit device 400 to receive information from another device and/or provide information to another device. For example, communication interface 470 may include an Ethernet interface, an optical interface, a coaxial interface, an infrared interface, a radio frequency (RF) interface, a universal serial bus (USB) interface, a Wi-Fi interface, a cellular network interface, or the like.

Device 400 may perform one or more processes described herein. Device 400 may perform these processes based on the processor 420 executing software instructions stored by a non-transitory computer-readable medium, such as memory 430 and/or storage component 440. A computer-readable medium is defined herein as a non transitory memory device. A memory device includes memory space within a single physical storage device or memory space spread across multiple physical storage devices.

Software instructions may he read into memory 430 and/or storage component 440 from another computer-readable medium or from another device via communication interface 470. When executed, software instructions stored in memory 430 and/or storage component 440 may cause processor 420 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

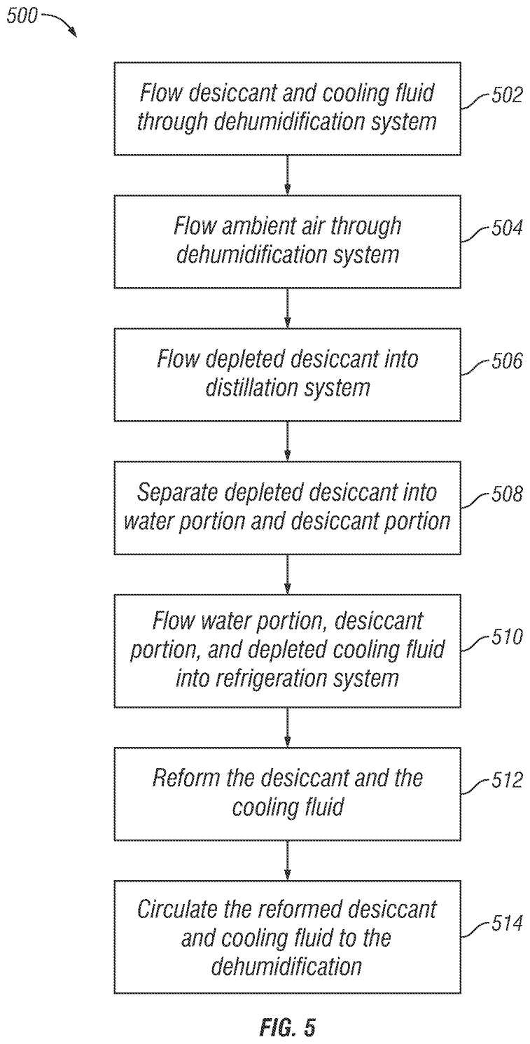

Referring to FIG. 5, a flow chart of an embodiment of a process 500 for air conditioning is illustrated. In some embodiments, one or more process blocks of FIG. 5 may be performed by the systems 302, 304, 306, 308 and/or devices 309, 310A, 310B, 310C of environment 300.

As shown in FIG. 5, the process 500 may include flowing 502 fresh liquid desiccant and fresh cooling fluid through the dehumidification system in a closed loop. The fresh liquid desiccant and fresh cooling fluid have an input temperature flowing into the dehumidification system. Ambient air flows 504 through the dehumidification system, wherein the ambient air has an initial humidity and an initial temperature. As the ambient air flows through the liquid desiccant, the liquid desiccant absorbs water from the ambient air, which reduces the humidity of the ambient air. The liquid desiccant is thereby converted into a depleted liquid desiccant. As the ambient air flows through the cooling fluid, the cooling fluid absorbs heat from the ambient air, which reduces the temperature of the ambient air. The fresh cooling fluid is thereby converted into a depleted cooling fluid.

The process 500 further includes flowing 506 the depleted liquid desiccant into a distillation system, wherein the depleted liquid desiccant is separated 508 into water and liquid desiccant. The water, the liquid desiccant, and the depleted cooling fluid are flowed 510 into a refrigeration system. The refrigeration system cools the liquid desiccant to the inlet temperature, thereby reforming 512 the fresh liquid desiccant for circulating 514 into the dehumidification system. The refrigeration system combines the depleted cooling fluid and the water into a combined depleted cooling fluid. The refrigeration system cools the combined depleted cooling fluid to the inlet temperature, thereby reforming 512 the fresh cooling fluid for circulating 514 into the dehumidification system.

In at least one embodiment, the dehumidification system comprises a first desiccant device, a cooling device, and a second desiccant device. The first desiccant device, the cooling device, and the second desiccant device are positioned in parallel in the dehumidification system. The fresh liquid desiccant flows through the first and second desiccant devices, and the fresh cooling fluid flows through the cooling device. The flow of ambient air passes through the first desiccant device, the cooling device, and the second desiccant device. The fresh liquid desiccant flowing through the first and second desiccant devices absorbs water from the ambient air and reduces the humidity of the ambient air, thereby converting the fresh liquid desiccant into a depleted liquid desiccant. The fresh cooling fluid flowing through the cooling device absorbs heat from the ambient air and reduces the temperature of the ambient air, thereby converting the fresh cooling fluid into a depleted cooling fluid.

In another embodiment, the distillation system comprises a heat exchanger and a separator, the heat exchanger and the separator are in fluid communication. The heat exchanger heats the depleted liquid desiccant, thereby creating a multi-phase fluid comprising a liquid desiccant portion and a water portion. The separator separates the multi-phase fluid into the water and the liquid desiccant.

In another embodiment, the process includes circulating a working fluid through the refrigeration system and the heat exchanger. The refrigeration system comprises a refrigerator fluidly connected to the heat exchanger, a desiccant reservoir thermally connected to the refrigerator, and a fluid reservoir thermally connected to the refrigerator. The liquid desiccant flows into the desiccant reservoir, and the depleted cooling fluid and the water are combined in the fluid reservoir. The working fluid circulates through the refrigerator and the heat exchanger. The working fluid absorbs heat from the liquid desiccant and the combined depleted cooling fluid while circulating through the refrigerator. The working fluid transfers the absorbed heat to the depleted liquid desiccant while circulating through the heat exchanger.

In another embodiment, the process includes the dehumidification system having a plurality of air flow sensors positioned in series along a length of the dehumidification system. The plurality of air flow sensors are configured to measure temperature and humidity of the stream of air at the various positions in the dehumidification system. The dehumidification system further comprises a plurality of control valves fluidly connected to inlets and outlets of the first desiccant device, the cooling device, and the second desiccant device.

In another embodiment, the process includes adjusting a flow rate of the fresh liquid desiccant entering the first and second desiccant devices. The process further includes adjusting a flow rate of the fresh cooling fluid entering the cooling device. The adjustment is based on the measured temperature and humidity of any of the plurality of air flow sensors being within a threshold temperature and threshold humidity. For example, each air flow sensor may be assigned a threshold temperature and humidity. If the temperature or humidity exceeds the maximum of the threshold of one or more air flow sensors, the flow rates of the fresh liquid desiccant and fresh cooling fluid may be increased. Additionally, or alternatively, the temperature of the fresh liquid desiccant and fresh cooling fluid may be decreased. If the temperature or humidity exceeds the minimum of the threshold, the flow rates of the fresh liquid desiccant and fresh cooling fluid may be decreased. Additionally, or alternatively, the temperature of the fresh liquid desiccant and fresh cooling fluid may be increased.

In another embodiment, the inlet temperature of the fresh liquid desiccant and the fresh cooling fluid is between about 35° F. and about 60° F.

In another embodiment, the distillation system comprises an Air heat exchanger fluidly connected to an inlet of the dehumidification system. The air heat exchanger has a first inlet, a first outlet, a second inlet, and a second outlet. The stream of air flows through the first inlet and outlet before flowing through the dehumidification system. The portion of the stream of air exiting the dehumidification system is recycled through the second inlet and outlet, thereby cooling the stream of air flowing through the first inlet and outlet.

While various embodiments in accordance with the principles disclosed herein have been described above, it should be understood that they have been presented by way of example only and not limitation. Thus, this disclosure's breadth and scope should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure but should not be constrained by the headings set forth herein.

What is claimed:

1. An air conditioning system for conditioning a stream of air using a closed loop desiccant circulation and a closed loop cooling fluid circulation, comprising:
a dehumidification system defining a flow path for the stream of air, the dehumidification system comprising at least one desiccant device in the flow path and a cooling device in the flow path, wherein:
the at least ono desiccant device is configured to decrease a humidity in the stream of air by absorbing water with a fresh liquid desiccant, the fresh liquid desiccant having an inlet temperature, and wherein absorption of the water by the fresh liquid desiccant forms a depleted liquid desiccant; and
the at least one cooling device is configured to decrease a temperature of the stream of air by absorbing heat with a fresh cooling fluid, the fresh cooling, fluid having the inlet temperature, and wherein absorption of the heat by the fresh cooling fluid forms a depleted cooling fluid;
a distillation system having an inlet, a first outlet, and a second outlet, the inlet is fluidly connected to an outlet of the at least one desiccant device, wherein the distillation system is configured to separate the water from the depleted liquid desiccant; and
a refrigeration system having a first inlet fluidly connected to the first outlet of the distillation system, a second inlet fluidly connected to the second outlet of the distillation system, a third inlet fluidly connected to an outlet of the at least one cooling device, a first outlet fluidly connected to an inlet of the at least one desiccant device, and a second outlet fluidly connected to an inlet of the at least one cooling device, wherein the refrigeration system is configured to:
cool the depleted liquid desiccant to about the inlet temperature of the fresh liquid desiccant to reform the fresh liquid desiccant;
combine and cool the water and the depleted cooling fluid to about the inlet temperature to reform the fresh cooling fluid; and
circulate the fresh cooling fluid and the fresh liquid desiccant to the at least one cooling device and the at least one desiccant device.

2. The dehumidification system of claim 1 wherein:
each of the at least one desiccant device comprises:
an inert medium configured to increase a contact area between the fresh liquid desiccant and the stream of air;
a control valve fluidly connected between the first outlet of the refrigeration system and each inlet of the at least one desiccant device, wherein the control valve is configured to adjust a flow rate of the fresh liquid desiccant;
a spraying head fluidly connected to each inlet of the at least one desiccant device, wherein the spraying head is configured to spray the fresh liquid desiccant into the at least one desiccant device; and
a collector fluidly connected to each outlet of the at least one desiccant device, wherein the collector is configured to collect the depleted liquid desiccant;
each of the at least one cooling device comprises:
an inert medium configured to increase a contact area between the fresh cooling fluid and the stream of air;
a control valve fluidly connected between the second outlet of the refrigeration system and each inlet of the at least one cooling device, wherein the control valve is configured to adjust a flow rate of the fresh cooling fluid;
a spraying head fluidly connected to each inlet of the at least one cooling device, wherein the spraying head is configured to spray the fresh cooling fluid into the at least one desiccant device; and
a collector fluidly connected to each outlet of the at least one cooling device, wherein the collector is configured to collect the depleted cooling fluid.

3. The distillation system of claim 2, further Comprising a heat exchanger and a separator positioned in series, wherein the heat exchanger is configured to heat the depleted liquid desiccant, and wherein the separator is configured to separate the water from the depleted liquid desiccant.

4. The distillation system of claim 3, further comprising a first cooler fluidly connected to a first outlet of the separator and a second cooler fluidly connected to a second outlet of the separator, wherein the first and second coolers are configured to cool the water and the depleted liquid desiccant to the inlet temperature.

5. The refrigeration system of claim 3, further comprising a refrigerator fluidly connected to the heat exchanger, a fluid reservoir thermally connected to the refrigerator, a desiccant reservoir thermally connected to the refrigerator, a fluid pump fluidly connected between the fluid reservoir and the at least one cooling device, a desiccant pump connected between the desiccant reservoir and the at least one desiccant device, and a plurality of control valves, wherein:
fluid flow through each inlet and outlet of the refrigerator, the desiccant reservoir, and the fluid reservoir is controlled by a respective control valve of the plurality of control valves;
the refrigerator is configured to absorb heat from the fluid reservoir and desiccant reservoir with a working fluid circulating between the heat exchanger and the refrigerator, the working fluid transferring the absorbed heat to the depleted liquid desiccant;
the fluid reservoir is configured to combine and cool the water and the depleted cooling fluid to the inlet temperature to reform the fresh cooling fluid;
the desiccant reservoir is configured to cool the depleted liquid desiccant to the inlet temperature of the fresh liquid desiccant to reform the fresh liquid desiccant; and
the fluid and desiccant pumps are configured to transfer the fresh cooling fluid to the at least one cooling device and the fresh liquid desiccant to the at least one desiccant device.

6. The dehumidification system of claim 5, further comprising a filter positioned at an inlet of the flow path and a fan positioned downstream from the filter, wherein the filter is configured to remove particles from the stream of air; and wherein the fan is configured to drive the stream of air through the dehumidification system.

7. The dehumidification system of claim 6, further comprising a plurality of air flow sensors positioned in series along a length of the flow path, wherein the plurality of air flow sensors are configured to measure temperature and humidity of the stream of air along the flow path.

8. The dehumidification system of claim 7, wherein:
each of the at least one desiccant device consists of a first desiccant device and a second desiccant device; and wherein the at least one cooling device, the first desiccant device, and the second desiccant device are positioned in series, with the at least one cooling device positioned between the first and second desiccant devices; and
the plurality of air flow sensors consists of: a first air flow sensor positioned between the filter and the fan, a second air flow sensor positioned between the fan and the first desiccant device, a third air flow sensor positioned between the first desiccant device and the at least one cooling device, a fourth air flow sensor positioned between the at least one cooling device and the second desiccant device, and a fifth air flow sensor positioned downstream from the second desiccant device.

9. The air conditioning system of claim 8, further comprising a computing platform, wherein:
the dehumidification system comprises a microprocessor communicatively coupled to the plurality of air flow sensors, each of the control valves, and the fan; wherein the refrigeration system comprises a microprocessor communicatively coupled to each of the control valves and each of the pumps; and wherein the distillation system comprises a microprocessor communicatively coupled to each of the control valves, the heat exchanger, the separator, and each of the pumps; and
the microprocessor of the dehumidification system is configured to adjust a flow rate of the fresh liquid desiccant and the fresh cooling fluid, and adjust a speed of the fan; wherein the microprocessor of the refrigeration system is configured to adjust a flow rate of: the working fluid, the water and the depleted liquid desiccant, and the fresh liquid desiccant and the fresh cooling fluid; and wherein the microprocessor of the distillation system is configured to adjust a flow rate of: the working fluid, the depleted liquid desiccant, and the water and the depleted liquid desiccant; and
the computing platform is in communication with each of the microprocessors, and wherein the computing platform is configured to adjust operations of at least one of: the dehumidification system, the refrigeration system, and the distillation system, based on the measured temperature or humidity of any of the plurality of air flow sensors.

10. The distillation system of claim 1, further comprising an air heat exchanger having a first inlet, a first outlet, a second inlet, and a second outlet; wherein the air heat exchanger is fluidly connected to an inlet of the flow path, and wherein the air heat exchanger is configured to cool the stream of air flowing through the first inlet and outlet by recycling the stream of air exiting the flow path through the second inlet and outlet.

11. The air conditioning system of claim 1, wherein the inlet temperature of the fresh liquid desiccant is between about 35° F. and about 60° F., wherein the inlet temperature of the fresh cooling fluid is between about 35° F. and about 60° F., and wherein the fresh cooling fluid comprises water, and wherein the fresh liquid desiccant comprises an ionized salt.

12. The distillation system of claim 4, wherein:
the first cooler has a first inlet, a first outlet, a second inlet, and a second outlet, and wherein the first cooler is configured to cool the water flowing through a first inlet and outlet by recycling the stream of air exiting the flow path through a second inlet and outlet; and
the second cooler has a first inlet, a first outlet, a second inlet, and a second outlet, and wherein the second cooler is configured to cool the depleted liquid desiccant by recycling the stream of air exiting the flow path through a second inlet and outlet.

13. A method for air conditioning using a dosed loop desiccant circulation and a closed loop cooling fluid circulation, comprising the steps of:
circulating a fresh liquid desiccant and a fresh cooling fluid through a dehumidification system, wherein the fresh liquid desiccant and the fresh cooling fluid flow into the dehumidification system at an inlet temperature;
flowing ambient air having an initial humidity and an initial temperature through the fresh liquid desiccant and the fresh cooling fluid;
reducing the humidity of the ambient air with the fresh liquid desiccant, thereby forming a depleted liquid desiccant;
reducing the temperature of the ambient air with the fresh cooling fluid, thereby forming a depleted cooling fluid;
separating water from the depleted liquid desiccant
combining the water and the depleted cooling fluid;
cooling the combined water and depleted cooling fluid to about the inlet temperature, thereby reforming the fresh cooling fluid;
cooling the depleted liquid desiccant to about the inlet temperature, thereby reforming the fresh liquid desiccant; and
circulating the fresh liquid desiccant and the fresh cooling fluid to the dehumidification system.

14. The method of claim 13, wherein the step of separating the depleted liquid desiccant includes circulating the depleted liquid desiccant through a distillation system having a heat exchanger and a separator, wherein the heat exchanger heats the depleted liquid desiccant, and wherein the separator separates water from the depleted liquid desiccant.

15. The method of claim 14, further comprising after the step of circulating the depleted liquid desiccant through the distillation system, circulating the water, the depleted liquid desiccant, and the depleted cooling fluid into a refrigeration system, wherein:
the step of separating the depleted liquid desiccant includes heating the depleted liquid desiccant with a working fluid circulating between the distillation system and the refrigeration system;
the step of cooling the water and the depleted cooling fluid includes absorbing heat from the water and the depleted cooling fluid with the working fluid; and
the step of cooling the depleted liquid desiccant includes absorbing heat from the depleted liquid desiccant with the working fluid.

16. The method of claim 13, wherein the step of circulating a fresh liquid desiccant and a fresh cooling fluid through the dehumidification system includes circulating the fresh liquid desiccant through a first and second desiccant device, and circulating the fresh cooling fluid through a cooling device.

17. The method of claim 16, wherein:
the step of flowing ambient air includes measuring the humidity and temperature of the ambient air with a plurality of air flow sensors positioned along a length of the dehumidification system; and
the step of circulating the fresh liquid desiccant and the fresh cooling fluid includes adjusting a flow rate of the fresh liquid desiccant and the fresh cooling fluid when at least one of the measured temperature and humidity from any of the plurality of air flow sensors is not within a threshold amount.

18. The method of claim 17, further comprising recycling a portion of ambient air exiting the dehumidification system to a refrigeration system to cool at least one of the water and the depleted liquid desiccant.

19. The method of claim 13, wherein the inlet temperature of the fresh liquid desiccant is between about 35° F. and about 60° F., wherein further the inlet temperature of the fresh cooling fluid is between about 35° F. and about 60° F., wherein further the fresh cooling fluid comprises water, and wherein the fresh liquid desiccant comprises an ionized salt.

20. The method of claim 13, further comprising recycling a portion of ambient air exiting the dehumidification system to a heat exchanger fluidly coupled to the inlet of the dehumidification system to cool the ambient air flowing into the dehumidification system.
